(19) United States
(12) Patent Application Publication
(10) Pub. No.: US 2005/0123763 A1
(43) Pub. Date: Jun. 9, 2005

(54) Colored activated carbon and method of preparation

(76) Inventors: Laurence H. Hiltzik, Charleston, SC (US); Edward Donald Tolles, Charleston, SC (US); G. Frederick Hutter, Charleston, SC (US); David R. B. Walker, Lansdale, PA (US)

Correspondence Address: Terry B. McDaniel;MeadWestvaco Corporation, 5255 Virginia Avenue, Post Office Box 118005, Charleston, SC, 29423-8005, US

(21) Appl. No.: 10/985,410

(22) Filed: Nov. 10, 2004

Related U.S. Application Data
(63) Continuation-in-part of application No. 10/287,492, filed on Nov. 5, 2002.
Application No. 10/287,492 is a continuation-in-part of application No. 09/448,034, filed on Nov. 23, 1999, now abandoned.

(30) Foreign Application Priority Data
Feb. 10, 2000 (BE) 00102722.6
Feb. 9, 2000 (CA) 2,298,232
Feb. 10, 2000 (CN) 00105398.1
Feb. 10, 2000 (EP) 00102722.6
Feb. 10, 2000 (FR) 00102722.6
Feb. 10, 2000 (DE) 00102722.6
Feb. 10, 2000 (GB) 00102722.6
Feb. 10, 2000 (NL) 00102722.6
Feb. 10, 2000 (HK) 00105398.1
Feb. 10, 2000 (JP) 2000-34349
Feb. 9, 2000 (KR) 2000-6020
Feb. 9, 2000 (MX) 001,414

(51) Int. Cl. B32B 5/16; B05D 3/02

(52) U.S. Cl. 428/407; 427/221; 427/372.2

(57) ABSTRACT

Color-coated activated carbon and method of preparation are disclosed in the product of application of a thin, continuous coating of an insoluble colorant-containing polymer emulsion on the material, without causing a reduction in adsorption capacity of the untreated activated carbon. In addition, the resultant avoidance of carbon dust leads to improved performance for contaminant removal.

This application is a Continuation-in-Part application of commonly assigned, co-pending U.S. patent application Ser. No. 10/287,492 titled “Coated Activated Carbon for Automotive Emission Control,” by L. H. Hiltzik, E. D. Tolles, and D. R. B. Walker, filed on Nov. 5, 2002, which was a Continuation-in-Part application of Ser. No. 09/448,034 titled “Coated Activated Carbon,” by L. H. Hiltzik, E. D. Tolles, and D. R. B. Walker, filed on Nov. 23, 1999, and now abandoned. This application is also related to commonly assigned, co-pending application Ser. No. 10/929,845, titled “Coated Activated Carbon for Contamination Removal from a Fluid, by L. H. Hiltzik, E. D. Tolles, and D. R. B. Walker, and filed Aug. 30, 2004, which was Continuation-in-Part of Ser. No. 10/287,493, now abandoned, which in turn was a Continuation-in-Part of Ser. No. 09/448,034 titled “Coated Activated Carbon,” by L. H. Hiltzik, E. D. Tolles, and D. R. B. Walker, filed on Nov. 23, 1999, the ultimate parent of this application.

### BACKGROUND OF THE INVENTION

1. Field of the Invention

This invention relates to color coated activated carbon material and a method for coloring activated carbon. In particular, this invention relates to coloring activated carbons in a manner which also reduces dust content and attrition due to abrasion and vibration where dusting can result in loss of product adsorptive performance, as well product material itself, yet in a manner that does not cause a reduction in adsorption capacity of the untreated activated carbon.

2. Description of Related Art (Including Information Disclosed Under 37 CFR 1.97 and 37 CFR 1.98

Active carbon long has been used for removal of impurities and recovery of useful substances from liquid and gas fluid streams because of its high adsorptive capacity. Generally, “activation” refers to any of the various processes by which the pore structure is enhanced. Typical commercial activated carbon products exhibit a surface area (as measured by nitrogen adsorption as used in the B.E.T. model) of at least 300 m²/g. For the purposes of this disclosure, the terms “active carbon” and “activated carbon” are used interchangeably. Typical activation processes involve treatment of carbon sources, such as resin wastes, coal, coal coke, petroleum coke, lignites, polymeric materials, and lignocellulosic materials including pulp and paper, residues from pulp production, wood (like wood chips, sawdust, and wood flour), nut shell (like almond shell and coconut shell), kernel, and fruit pits (like olive and cherry stones) either thermally (with an oxidizing gas) or chemically (usually with phosphoric acid or metal salts, such as zinc chloride).

Chemical activation of wood-based carbon with phosphoric acid (H₃PO₄) is disclosed in U.S. Pat. No. Re. 31,093 to improve the carbon's decolorizing and gas adsorbing abilities. Also, U.S. Pat. No. 5,162,286 teaches phosphoric acid activation of wood-based material which is particularly dense and which contains a relatively high (30%) lignin content, such as nut shell, fruit stone, and kernel. Phosphoric acid activation of lignocellulose material also is taught in U.S. Pat. No. 5,204,310 as a step in preparing carbons of high activity and high density.

Also, U.S. Pat. No. 4,769,359 teaches producing active carbon by treating coal cokes and chars, brown coals or lignites with a mixture of NaOH and KOH and heating to at least 500° C. in an inert atmosphere. U.S. Pat. No. 5,102,855 discloses making high surface area activated carbon by treating newspapers and cotton linters with phosphoric acid or ammonium phosphate. Coal-type pitch is used as a precursor to prepare active carbon by treating with NaOH and/or KOH in U.S. Pat. No. 5,143,889.

Once the activated carbon product is prepared, however, it is black and may be subject to degradation before and during its use. The natural black color of the activated carbon, whether used in its pure form or as a component in a composite monolith, fabric, or sheet, does not detract from its performance for contaminant removal, per se, yet the color leaves the carbon unattractive, which is undesirable for use in consumer or personal care products, and leaves the carbon without distinctive appearance, as might be useful for brand identification or manufacturing quality assurance. There is also no means to visibly indicate depleted adsorptive properties during use.

The degradation of the carbon by abrading during materials handling and actual use results in loss of material in the form of dust. Such “dusting” of the product is a function of its relative hardness and its shape, as well as how it is handled in the plant, in moving it into and out of plant inventory, in loading for transport and in off-loading by the receiver, and in how it is handled by the receiver to place the product into use. In certain applications, where the activated carbon is subject to vibration or erosion, product degradation by dusting continues through the life of the product. The dust in a carbon bed is a nuisance in that it has the potential to contaminate the fluid stream being treated, to increase flow resistance of the filter device by clogging the bed and downstream particulate filters, and to disrupt the uniform flow of fluid through the bed by creating high flow restriction “dead zones.” The dust is also unattractive. For example, manufacturers of filters used for removing contaminants from fluid streams often direct users to flush carbon filters of dust before a filter is put into service. Though effective for removing the dust initially present in the filter, this procedure does not eliminate dusting during subsequent use, and the flushing, as might be employed for a point-of-use water filter, wastes useful filtering capacity. Therefore, means to eliminate the dusting of carbon as might occur during filter assembly and during filter use are highly valued.

The tendency for dusting is a normal property of activated carbon that can vary according to the precursor material and the manufacturing method. The hardness and abrasion resistance of the precursor material often determines the hardness of the activated carbon material, such as a typical coal-based activated carbon being harder than a typical wood-based activated carbon. The shape of granular activated carbon also is a function of the shape of the precursor material. The irregularity of shape of granular activated carbon, i.e., the availability of multiple sharp edges and corners, contributes to the dusting problem. Of course, relative hardness and shape of the activated carbon are both subject to modification. The modified activated carbon may be in the form of beads, pellets, fibers, blocks, monoliths, honeycombs, and woven and nonwoven sheets according to a wide array of methods. For example, U.S. Pat. Nos. 4,677,086, 5,324,703, and 5,538,932 teach methods for making pellet products of high density from lignocellulosic precursors. Also, U.S. Pat. No. 5,039,651 teaches a method of producing shaped activated carbon from cellulosic and starch precursors in the form of “tablets, plates, pellets, briquettes, or the like.” Further, U.S. Pat. No. 4,221,695 discloses making an “Adsorbent for Artificial Organs” in the form of beads by mixing and dissolving petroleum pitch with an aromatic compound and a polymer or copolymer of a chain hydrocarbon, dispersing the resultant mixture in water giving rise to beads, and subjecting these beads to a series of treatments of removing of the aromatic hydrocarbon, infusibilizing, carbonizing, and finally activating. U.S. Pat. No. 5,914,294 teaches a method for making activated carbon in the form of a single or multiple parallel passage honeycomb or monolith using a ceramic forming material and a flux material. U.S. Pat. Nos. 4,904,343, 5,147,722, and 6,746,760 teach methods for making activated carbon-containing sheets in the non-woven sheet form, and U.S. Pat. Nos. 4,285,831, 4,457,345, and 6,156,287 teach methods for making activated carbon fibers, yarns, and woven fabric.

Despite these and other methods of affecting activated carbon hardness and shape, product dusting continues to be a problem in many applications, and the shaped carbon remains essentially black in color, either as the major component in the carbon filter or article, or as a minor yet visibly contrasting component in the finished product. For example, in U.S. Pat. No. 4,221,695, noted above, the patentees describe conventional beads of a petroleum pitch-based activated carbon intended for use as the adsorbent in artificial organs through which the blood is directly infused that are not perfectly free from carbon dust. They observe that some dust steals its way into the materials in the course of the preparation of the activated carbon, and some dust forms when molded beads are subjected to washing and other treatments. The patentees reflected conventional wisdom in noting that the application of a film-forming substance to the surface of the adsorbent “is nothing to be desired,” because the applied substance acts to reduce the adsorption velocity of the matters to be adsorbed on the adsorbent and limit the molecular size of such matters being adsorbed.

Subsequently, however, in U.S. Pat. No. 4,476,169, the patentees describe a multi-layer glass window wherein vapor between the glass sheets is adsorbed by a combination of granular composite zeolite particles and granular activated carbon particles coated with 1-20 wt % synthetic resin latex, including styrene- and nitrile-based polymers. The coating of the activated carbon is described as greatly inhibiting the occurrence of dust without substantially reducing the absorptive power of activated carbon for an organic solvent. One limitation of this invention is that, though perhaps glossy in appearance, the coated activated carbon remains black, albeit this limitation is not of consequence for an application where the carbon is encased in the multipane window frame and hidden from view. Other applications where the activated carbon is potentially visible to the consumer, such as the freshness keeping sheet of U.S. Pat. No. 5,436,067 and the deodorizing and exhaust gas treatment filter of U.S. Pat. No. 5,403,548, an attractive appearance of the activated carbon-containing filter article may otherwise be highly prized as complementing the cleaning function of the filter. For improving the appearance and the reducing the propensity for dusting for some activated carbon materials, masking layers are used, as taught by U.S. Pat. Nos. 4,983,192, 5,674,339, and 6,485,813 for activated carbons incorporated into sheet forms. While these inventions reduce dusting, they also have the drawbacks of increasing the bulk of the article and reducing its flexibility. Furthermore, an open weave or highly porous filter medium designed for low resistance of air flow through the filter medium, as taught by U.S. Pat. No. 6,746,760, must have sufficiently thick masking, open weave or porous layers to render the activated carbon component of the article invisible. The added thickness is counter to the intent of providing high air permeability.

The present invention relates to the discovery that activated carbon in granular, beaded, pelletized, fiber, block, honeycomb, monolith, fabric, or sheet form can be colored by applying pigment in a thin coating film while also providing the benefit of dust-free properties, without affecting adsorptive properties, and without appreciably adding to the bulk or volume of the activated carbon material. The color coating may be applied to the finished product where the activated carbon is a component and may be applied to the activated carbon prior to incorporating it into the final filter shape or form. Though prior art has shown how to make carbon dust-free by polymer coatings, it was not obvious when reduced to practice on how to incorporate color onto the carbon while maintaining the benefits of the coating. For example, it was found that soluble dyes are ineffective for coloring activated carbon since these compounds are readily adsorbed by the activated carbon, yielding a black product and one that potentially leaches color afterwards when placed in a liquid in which the dye is soluble. The barrier to using a dye is due to the exceptionally strong adsorptive properties of activated carbon that preferentially removes the dye from the coating during its application on the external surface of the activated carbon. Soluble dyes are adsorbed even if, in an attempt to hinder uptake of the dye, the carbon is pre-wetted, saturated with liquid, or pre-coated with a polymer film. Furthermore, it has been found that common insoluble organic pigments, despite their wide array of colors, do not necessarily yield the desired hue or value of color when applied in a useful amount in the carbon coating or with a useful amount of total coating, i.e., a coating amount and composition would still be dust-free and allow retention of adsorption capacity. A strong yellow pigment, such as diarylide yellow, in the coating gives a green carbon, and the carbon is only weakly colored when coated with reasonable amounts of blue or red pigment, such as phthalo blue or naphthol red.

There are numerous benefits provided by the colored activated carbon made by the present invention. Color activated carbon is attractive and can be applied for aesthetic purposes, such as for refrigerator deodorization and carafe-type filters for point-of-use (POU) water treatment, so that the activated carbon is not black and has a color that visibly complements the cleanliness of the filtered air or water. In manufacture, different colors can provide an effective means of differentiating between different activated carbon grades, such as grades for chlorine removal and grades for chloramine removal for POU filters, and thereby eliminating confusion between carbon grades when assembling the filter. Also, color can be used to identify the year of manufacture, provide quality assurance, and provide brand identification. For example, a filter manufacturer could demand a special color on their activated carbon filter media to assure that some other manufacturer's activated carbon is not used in its place in the filter assembly by a third party.

Colored coatings may provide a visible indicator to show when a carbon filter is spent, such as by including a compound in the coating that changes, gains, or loses color when exposed to a contaminant. In order to make an indicator coating feasible, a base coating with an opacity pigment is applied by the present invention and the indicator is readily visible against a suitable background color rather than virtually invisible against the natural black color of the carbon. By successfully incorporating the indicator in a coating, added with a pigment or over a base coating of appropriate opacity, the filter is taken out of service and replaced when it is visibly depleted in its capacity prior to breakthrough of contaminants from the filter or upon saturation, compared with removing the filter prematurely or leaving the filter in service after its useful life is complete, to thereby allow contaminants to elute into the filter effluent or to accumulate in the environment around the filter. If an indicator color compound is naturally soluble, it may be necessary to have the indicator affixed to the polymer in the spray emulsion, such as by grafting the indicator compound to the polymer, incorporating the indicator as co-polymer component, or affixing the indicator to an insoluble coating component or carrier.

In the preparation of coated carbon, the presence of pigment in the emulsion spray also has utility. The pigment in the coating allows an on-the-spot visual verification of complete coverage by the coating on the carbon. Without the pigment present, the clear coated carbon might have to be tested after the fact to confirm that the desired minimum coating coverage had been obtained. The ability for a color coverage-based visual inspection is a benefit for adjusting the amount of spray, either manually or automatically, in order to compensate for changes in external surface that might be encountered, such as from changes or variations in particle size or shape.

### SUMMARY OF THE INVENTION

It has been discovered that color-coated activated carbon materials can be made in a manner which significantly reduces, or essentially eliminates, dust and attrition due to abrasion and vibration during manufacture and use, and yet made in a manner that does not cause a reduction in adsorption capacity of the untreated activated carbon. Method of preparation is disclosed by which a thin, continuous coating of a pigment-containing polymer emulsion is applied on the activated carbon material, followed by drying.

A key feature of the invention is that the color coating provides activated carbons with a glossy and attractive appearance that calls attention to product cleanliness and complements the cleanliness of the environment treated by the activated carbon. The glossy nature of the coating results from the film-forming nature of the polymer and the emulsion form by which it is applied to the pellets. A variety of colored carbons can be prepared by choosing the proper combination of insoluble coloring agents or colorants for addition to the polymer emulsion and the emulsion application methods, as taught in the foregoing examples, in order to attain the desired color hue and value, plus obtain the desired low dust benefits of the polymer coating film. In the context of the invention, the term “colorant” is intended to include organic and inorganic, natural and artificial pigments, lakes, chromophores, indicator compounds, and optical brighteners. An indicator compound may be colorless in its application on the carbon and in its initial use, initially yielding a black coated carbon or a carbon colored with a color of a base coating, yet gain color when exposed to in-use conditions to signify exposure to a change in environmental conditions, such as identifying that the activated carbon's adsorptive capacity is saturated. Conversely, when exposed to a change in environmental conditions, the carbon may change color to black, to the color of the base coating, or to a different color of than the starting hue. Colorants are applied in an insoluble form, including in the form of a naturally insoluble compound, a copolymer with emulsified polymer, or made insoluble by grafting or attaching to the emulsion polymer or to an insoluble carrier component in the spray solution. Methods for adding a naturally insoluble colorant include adding it as a powder to the spray emulsion, adding the powder in the form of a dispersion to the spray emulsion, adding the powder or dispersion to the melted polymer prior to emulsification, and co-melting powder and polymer prior to emulsification.

Distinctive carbon products are achieved through color-coding. The color-coding may relate to product application, plant origination, customer designation, or any designation desired. Attractive colors of the carbon complement the cleanliness of the fluid or environment treated by the activated carbon. In manufacture, the color coating is also a visual indicator of complete and uniform coating coverage for a carbon coating operation. The presence of an indicator compound in the coating visually identifies when the adsorption capacity of an activated carbon material is spent and needs replaced, rather than leaving a spent filter or adsorptive material in-use beyond its useful life or prematurely replacing the filter when there is useful service life remaining.

Color coated activated carbon applies to activated carbon in its many forms, including granular, beads, pellets, fibers, honeycombs, monoliths, blocks, woven and non-woven fabrics, and sheets. Color coated carbon may first be prepared and then incorporated into these forms. Color coated carbon may be prepared after the form is made with the carbon, where the carbon is one of the components in the article or material and is visible. It is important that the carbon surface subject to view is uniformly coated in order attain the desired aesthetics of the color coating. For particulate or fiber carbon, the color coating is applied with the carbon in a kinetic state, such as attained in a rotary tumbler, a mixing device, vibrating screen, and a fluidized bed, rather than a static state. Honeycombs, monoliths, blocks, sheets, and fabrics are similarly color coated, coated in a static state, such as by moving the spray around the article, and coated while being extruded, rolled, or formed.

An additional result of the color coating is that the product has sharply reduced dusting attrition. For particulate activated carbon, for example, dust-free is shown by an “initial dust” value of ≦0.3 mg/dL and a “dust rate” value of ≦0.01 mg/min/dL, both below the detection limits of the standard dusting attrition test. The product is “essentially” dust free, as shown by a “dust rate” value of ≦0.06 mg/min/dL, a detectable value but dramatically lower than the dust rate of uncoated activated carbon and, as noted in the tables which follow in the examples below, is the highest dust rate value of the invention-treated activated carbons. Other examples are shown for particulate carbon samples agitated in water where the coating substantially reduces fines generation.

The process for making color coated activated carbon and essentially eliminating dusting attrition by coating the activated carbon material comprises the steps of:
(a) spraying insoluble colorant-containing polymer emulsion onto exposed surfaces of the activated carbon material; and
(b) drying the coated activated carbon material.

The process may optionally include an initial step of preheating the active carbon material to above ambient temperature. The process may include multiple repetitions of steps (a) and (b). The repetitions may or may not include insoluble colorant, such as to apply a clear top coating in order to assure the sharp reduction in dusting attrition. Also, the process of the claimed invention may comprise a further step of:
(c) de-dusting the dried coated activated carbon material by removing any residual dust therefrom.

As those skilled in the art appreciate, various processing conditions are generally interdependent, such as processing time and processing temperature. These operating conditions as well may depend on the nature of the carbon material to be coated (shaped or granular, coal-based or lignocellulosic-based, etc.) and the coating material (relative volatility, viscosity, emulsion stability, etc.). Thus, the temperature range for coating application and coating drying steps may range from just below ambient of about 50° F., up to about 280° F. (138° C.), and the processing time may take from about 1 minute to about 12 hours. For most combinations of shaped or granular active carbon material and coating material, a preferred operating temperature range for the coating and drying steps is from about 70° F. (21° C.) to about 250° F. (121° C.) for from about 5 minutes to about 6 hours.

The active carbon of the invention described herein may be derived from any known active carbon precursors including coal, lignocellulosic materials, including pulp and paper, residues from pulp production, wood (like wood chips, sawdust, and wood flour), nut shell (like almond shell and coconut shell), kernel, and fruit pits (like olive and cherry stones), petroleum, bone, and blood.

The amount of emulsion solids to be applied for effectively eliminating dusting while leaving adsorptive properties unaffected will depend on the amount of external surface area to be coated, as determined by activated carbon size, shape, particle density, and surface roughness. The goal is to achieve an adequate coating on the external carbon surface of a few to several microns in thickness. For example, though achieving the benefits of the coating might require a certain loading of polymer on a typical 2 mm diameter activated carbon pellet, a greater amount of coating would be required for a smaller particle size, dₚ. Basic geometry dictates that the increased amount of coating needed for a smaller particle is roughly proportional to the reciprocal of the particle size, dₚ⁻¹, where the exact amount of coating for a given coating material is dependent on particle shape, particle density, and surface roughness. As those skilled in the art will appreciate, the desired loading range to gain the benefits of low dusting without hindering adsorptive performance will often best be determined by first applying an empirical method of coating a set of activated carbon samples with a range of polymer loadings. A minimum amount of polymer coating will at least be required to make the particles essentially dust-free. In some cases, such as when adding the colorant in a powder form, a marginally greater amount of polymer coating will be required to bind the colorant in the coating so that the desired reduction in dusting is achieved.

The desired amount of insoluble colorant also depends on the activated carbon size, shape, particle density, and surface roughness, as well as the specific gravity, color intensity, and opacity of the coloring agent, the presence and opacity of a basecoat on the activated carbon, and the desired color value of the product. Multiple coatings and combinations of different polymer and colorant types and amounts may be used to attain the desired color and dust-free properties of the product. Additives to the emulsion, as known in the arts of emulsions and dispersions, may be needed to maintain the stability of the polymer emulsion and the dispersion of insoluble colorant in the emulsion in order to uniformly and effectively spray the coating components onto the carbon.

The coating materials useful in the claimed invention are those capable of forming a continuous film. In particular, polymers, copolymers, and polymer blends that are suitable coating materials include: polyolefins, such as polyethylene, polypropylene, polyisobutylene, polystyrene, polyisoprene, polychloroprene, poly-4-methyl-1-pentene, polybutadiene, and polybutene; polyacrylics, such as polyacrylates, polymethyl methacrylate, polybutylmethacrylate, polymethacrylates, and polyacrylic acid; halogen-substituted alkanes, such as polytetrafluoroethylene, trifluoroethylene, vinyl fluoride, fluorvinylidene, fluorobutylene, and fluoropropylene; and other polymers including polyurethane, polyethylene terephthalate, styrene butadiene, modified polybutadiene, epoxies, modified alkyds, polyesters, starches, methyl cellulose, ethyl cellulose, carboxymethyl cellulose, polyvinyl acetate, cellulose acetate, cellulose nitrate, cellulose triacetate, cellulose acetate butyrate, cellulose acetate phthalate, cellulose propionate morpholinobutyrate, hydroxypropylmethyl cellulose, ethylene vinyl acetate, acrylic copolymers, polysulfones, polyether sulfones, polyethers, polyalkylene glycols, polyimines, polybutylene, polyvinyl ethers, polyvinyl esters, polyalkylsulfides, polyarylsulfides, lignosulfonates, polyacrylamide, cyanoacrylate, polyamides, polyimides, polysiloxanes, polymethacrylonitrile, polyacrylonitrile, polyvinylpyridine, polyvinyl acetate, polyvinylpyrrolidone, polyvinyl butyral, polyvinyl alcohol, polyvinyl chloride, polyvinyl formal, polyformaldehyde, polycarbonates, and polyvinylidene chloride.

Certain polymers may have advantages over others in that adsorption velocity may be comparatively less affected by the presence of the continuous polymer coating on the external surface for the activated carbon. For some uses, the effect on adsorption velocity may be less important and the selection of polymers may, therefore, be less limited on that basis. For example, for deodorizers in stagnant environments or environments where there is a high rate of fluid recirculation, such as refrigerators, the rate of adsorption is less critical. In contrast, for some applications, such as point-of-use water filters, there are filter design and performance advantages to minimizing the mass transfer zone across the flow path of the filter, and there may be substantial benefit in selecting polymers that do not hinder adsorption velocity. Polyethylene (PE) was discovered to be a most preferred polymer for the coating since it does not hinder adsorption velocity, in addition to not hindering adsorption capacity.

The following examples describe the method and properties of materials that have been treated.

### EXAMPLE 1

Samples of MeadWestvaco wood-based activated carbon pellets, 2 mm BAX 1500, were coated with aqueous polyethylene emulsions containing inorganic pigments. The activated carbon pellets were coated by tumbling in an inclined rotating cylinder and initially heated to 250° F. (121° C.) using a hot air gun. The pigment-containing polymer emulsion was then sprayed on the carbon in a single coating as the activated carbon was maintained at about 150° F. (66° C.) under the hot air flow. When spray coating the carbons, intermediate samples were taken during the spraying to determine a color “threshold” loading of pigment—the point at which color was initially visibly apparent on the activated carbon, expressed as g-pigment per 100 g-carbon. The coated activated carbon was then dried overnight at 220° F. (105° C.). A comparative coated sample was prepared with a comparable polyethylene loading, but without pigment.

The spray solutions were prepared by diluting the raw emulsion (Poly Emulsion 325N35 grade polyethylene emulsion with nonionic surfactant; ChemCor) with appropriate aliquots of water, and then adding the pigment in powder or dispersion form. The polyethylene solids concentrations prior to pigment addition are shown in Table I.

TABLE I

| | Sample ID: | | | | | | |
|---|---|---|---|---|---|---|---|
| | C1 | C2 | 1 | 2 | 3 | 4 | 5 |
| Coating | | | | | | | |
| Initial PE, wt % | — | 8.8 | 6.8 | 8.8 | 7.8 | 4.6 | 4.6 |
| in sol'n | | | | | | | |
| PE, g/100 g- | — | 2.0 | 1.1 | 2.0 | 1.8 | 1.7 | 1.7 |
| carbon | | | | | | | |
| Pigment | — | — | TiO₂ | Fe₂O₃ | pearlescent | Fe₂O₃ | (FeO)OH |
| Pigment | — | — | powder | powder | powder | disp. | disp. |
| Form | | | | | | | |
| Pigment Color | — | — | 1.0 | 1.0 | 0.5 | 1.0 | 0.5 |
| “Threshold,” | | | | | | | |
| g/100 g-carbon | | | | | | | |
| Acrylic Resin, | — | — | — | — | — | 0.3 | 0.3 |
| g/100 g-carbon | | | | | | | |
| Pigment, | — | — | 1.5 | 2.0 | 1.0 | 1.7 | 1.7 |
| g/100 g-carbon | | | | | | | |
| Product | | | | | | | |
| Properties | | | | | | | |
| Product Color | Flat | Glossy | Glossy | Glossy | Shiny | Glossy | Glossy |
| | black | black | blue-grey | red | red-brown | red | green-gold |
| Apparent | 0.281 | 0.283 | 0.277 | 0.282 | 0.290 | 0.296 | 0.295 |
| Density, g/cc | | | | | | | |
| Packing | 1.000 | 0.987 | 0.962 | 0.966 | 1.005 | 1.015 | 1.014 |
| Ratio | | | | | | | |
| Initial Dust, | 3.4 | 0.9 | 1.5 | 1.7 | 0.7 | 1.2 | 0.5 |
| mg/dL | | | | | | | |
| Dust Rate, | 0.20 | 0.02 | 0.02 | 0.03 | 0.05 | 0.00 | 0.00 |
| mg/min/dL | | | | | | | |
| Butane Activity, | 65 | 63 | 64 | 62 | 62 | 59 | 59 |
| g/100 g-product | | | | | | | |
| Butane Activity, | 65 | 63 | 65 | 65 | 64 | 61 | 62 |
| g/100 g-carbon | | | | | | | |
| Butane Activity, | 18.2 | 17.8 | 17.7 | 17.6 | 17.9 | 17.3 | 17.5 |
| g/dL-bed | | | | | | | |
| BWC, g/dL | 15.6 | 15.2 | 15.1 | 15.1 | 15.4 | 14.9 | 15.0 |
| Butane Ratio | 0.857 | 0.856 | 0.857 | 0.856 | 0.859 | 0.863 | 0.857 |

Samples 1-3 were prepared with the following pigments added as dry powders to the spray emulsions: White TiO₂ (TI-Pure® R-706; du Pont de Nemours and Company), red Fe₂O₃ (Synox® HR-1208; Hoover Color Corp.), and red-brown micaceous pearlescent (Afflair® 502; EMD Chemicals, Inc.). In preparing samples 4 and 5, red and yellow iron oxide pigments (RP-500M and Y-200M, respectively, from Delta Colours, Inc.) were added to the spray emulsions as dispersions. The dispersions had a formulation of dry pigment powder (35 wt %, shot mill-ground) added to an agitated aqueous blend of isopropyl alcohol (3 wt %), ammonia (4 wt %), and styrene/acrylic resin (7 wt % shot mill-ground MOREZ® 101; Rohm and Haas, Co.), followed by blender agitation for at least 30 minutes.

As shown in Table I, attractive color coated carbons were prepared when the pigments were included in the spray emulsions (samples 1 through 5), compared with the flat black color of the uncoated pellets (comparative sample C1) and the glossy black color of the pellets coated without pigment (comparative sample C2).

The apparent densities, or “AD” values, were measured by slow 0.75-1.0 sec/cc fill of 150 mL of activated carbon particles into a 250 mL glass graduated cylinder. The “Packing Ratio” was the amount of activated carbon in a packed bed volume of coated pellets relative to the amount of activated carbon in a packed bed of uncoated pellets, and therefore equal to the ratio of the activated carbon weight-basis AD for the coated pellets and the uncoated pellet AD. The carbon weight-basis AD for the coated pellets was the product of the coated pellet AD multiplied by the weight percent original activated carbon in the pellet (100%—wt % total coating loadings).

Table I compares the dusting attrition properties for uncoated and coated pellets. Dusting attrition rates were measured with the two-point method in a 30-minute test (described below).

Initial dust and dust rate values were measured by a modified, 3-filter version of the “Standard Test Method for Dusting Attrition of Granular Carbon” (ASTM D5159-91). A 1.0 dL sample of carbon is placed on a screen with 0.250 mm openings in a test cell holder and is subjected to vibration of 40 m/s/s RMS acceleration and downward air flow of 7.0 L/min for a 10 minute interval. A glass fiber filter, placed below the sample screen, collects dust from the sample. The vibration and airflow step is conducted three times with three different filters. The dust rate is calculated by the following equation:
Dust Rate(mg/min/dL),DR=0.0732w₃
where W₃ is the milligram weight gain of the third filter. The dust rate from this equation is within a standard deviation of ±13% of the dust rate obtained by the standard ASTM procedure that uses filter weight data from three additional 10 minute test intervals.

The initial dust is calculated as the milligram weight gain for the first filter, w₁, minus the amount of dust attrited within that first 10 minutes (10×DR):
Initial Dust(mg/dL)=w₁−10DR.

The inherent error in dust rate is ±0.01 mg/dL by a partial differential error analysis of its equation for calculation and the 0.1 mg readability of the four decimal place gram balance required in the procedure. Likewise, the inherent error in initial dust is ±0.3 mg/dL by the same analysis method. Therefore, the non-detect dust rate value would be 0.01 mg/min/dL and the non-detect initial dust value would be 0.3 mg/dL.

The butane activity and butane working capacity (BWC) values were determined according to the procedure described in U.S. Pat. No. 5,204,310 and such teaching is incorporated by reference herein. Butane activity is the weight gain of a small bed of activated carbon from equilibrium saturation with 100% n-butane vapors at 25° C. and 1 atmosphere, expressed as g-butane per 100 g-carbon or product. The BWC was measured according to the procedure described in U.S. Pat. No. 5,204,310 which involves subjecting the small bed of activated carbon to a clean air purge of about 600 bed volumes subsequent to the equilibrium saturation of the sample with 100% butane vapors at 25° C. The BWC value is typically reported on a volume-bed basis and is a widely accepted surrogate measure of working capacity performance of activated carbons for evaporative emission control canisters. BWC is related to the volume of small mesopores in the range of 18-50 Å size, as taught in U.S. Pat. No. 5,204,310, whereas total butane adsorption is related to the total amount of pores <50 Å in size. Smaller size pores, <18 Å, are strongly adsorbing and contribute to equilibrium adsorption but are not readily purgeable under the conditions of the test. Butane Ratio is defined as the proportion of the total butane that is purgeable (BWC divided by volume-basis butane activity) and, by extension, is related to the proportion of total pores less than 50 Å in size that are 18-50 Å in size which adsorb vapors with only moderate strength. Note that the BWC value is not an equilibrium property since, despite being related to the pore volume and pore size distribution of the activated carbon, hindered transport of vapors from the interior of activated carbon particle has the potential to reduce the rate, and therefore the cumulative total, removal of butane into the purge stream. A treatment to the carbon, such as a coating, that hinders vapor or contaminant transport into or out of the carbon, has the potential to reduce butane ratio even though the internal porosity of the carbon is otherwise unaffected.

As shown in Table I, the visible and attractive color feature of the coating was attained by the color coated activated carbons (samples 1 through 5) with the full benefits of the low dusting rate from the coating (comparative example C2) and with the adsorptive capacity and purgeability (including resistance to contaminant transport) of the carbons essentially intact. For applications that value the maximum fill of activated carbon in a packed bed, such as in an evaporative emission control canister or a POU water filter, the formulations of samples 1-5 that leavepacking density and adsorptive properties unaffected would be especially valued.

### EXAMPLE 2

Samples of Mead Westvaco wood-based activated granular carbon, RGC 40, a commercial grade activated carbon commonly used for water filtration and liquid phase purification, were sieved to 10×20 mesh and then coated with inorganic pigment powders suspended in polyethylene emulsion (Poly Emulsion 325N35; ChemCor) according to the following method. The gold color pigment was Afflair® 500 Bronze, the purple pigment was Afflair® 219 Rutile Lilac, and the silver pigment was Afflair® 119 Polar White, all from EMD Chemicals, Inc. The solids concentration of PE in the spray for coating was 8.8 wt % by diluting the raw emulsions with appropriate aliquots of water. Appropriate proportions of pigment powder were then added. The activated carbon granules were coated by tumbling in an inclined rotating cylinder. Solutions of the polymer emulsion and pigment were sprayed on the activated carbon at ambient temperature. The coated activated carbons were then dried for 16 hours at 220° F. (105° C.). One sample (sample 8) was prepared in a two-step coating procedure. A base coat containing pigment was applied, followed by a top coat of pigment-free emulsion, with a brief period of tumbling between coatings (˜10 minutes).

The propensity of the granular carbon to dust was determined by swirling 5.0 grams of activated carbon sample in 50.0 mL of filtered water and then measuring the transmittance of a liquid aliquot at a wavelength of 440 nm with a spectrophotometer (Milton Roy Spectronic 21D). A calibration between transmittance and dust concentration was made using water slurries containing known concentrations of carbon fines and pigment fines, both powder materials actually giving the same transmittance response as a function of concentration. Carbon fines for calibration were formed by milling the uncoated RGC carbon in a SPEX CertiPrep shaker ball mill for one minute. The apparent densities of the 10×20 mesh carbons were measured from the 100 mL fill in a 100 mL graduated cylinder at a slow, 0.75-1.0 sec/cc fill rate.

Attractive gold, purple, and silver color coated carbons were prepared (samples 6 through 8 in Table II). Carbon bed packing and adsorptive properties were unaffected by the presence of the coatings. The fines contents of the color coated samples were substantially reduced compared with the uncoated granular carbon (comparative sample C3). A greater reduction in fines content was achieved by applying a substantial portion of the PE as a pigment-free top coat film (sample 8).

TABLE II

| | Sample ID: | | | |
|---|---|---|---|---|
| | C3 | 6 | 7 | 8 |
| Base Coat | | | | |
| PE, g/100 g-carbon | — | 3.5 | 3.5 | 1.75 |
| Gold Pearlescent, g/100 g-carbon | — | 2.7 | 0 | 0 |
| Purple Pearlescent, g/100 g-carbon | — | 0 | 2.7 | 0 |
| Silver Pearlescent, g/100 g-carbon | — | 0 | 0 | 2.7 |
| Top Coat | | | | |
| PE, g/100 g-carbon | — | — | — | 1.75 |
| Product Properties | | | | |
| Product Color | Flat | Shiny | Shiny | Shiny |
| | black | gold | purple | silver |
| Apparent Density, g/cc | 0.297 | 0.314 | 0.312 | 0.314 |
| Packing Ratio | 1.000 | 0.997 | 0.990 | 0.997 |
| Fines Content, mg/dL-bed | 24.3 | 3.9 | 6.9 | 0.4 |
| Fines Reduction | — | −84% | −72% | −98% |
| vs. Uncoated | | | | |
| Butane Activity, g/100 g-product | 46 | 42 | 42 | 42 |
| Butane Activity, g/100 g-carbon | 46 | 45 | 45 | 45 |
| Butane Activity, g/dL-bed | 13.6 | 13.3 | 13.2 | 13.3 |
| BWC, g/dL | 11.1 | 11.0 | 10.9 | 11.0 |
| Butane Ratio | 0.815 | 0.827 | 0.827 | 0.827 |

### EXAMPLE 3

Samples of MeadWestvaco wood-based activated carbon pellets, 2 mm BAX 1100, a commercial grade activated carbon commonly used for evaporative emission control canisters, were coated with organic pigment-containing polyethylene emulsion according to the method of Example 2. The PE emulsion was Poly Emulsion 325N35 (ChemCor). The cyan and magenta pigments were added to the PE emulsion in aqueous dispersion form: Sunsperse® phthalocyanine blue BHD-6000 (54 wt % solids) and naphthol red 238, RHD-6012 (45 wt % solids), both from Sun Chemical Corp., Amelia, Ohio. These commercial pigment dispersions include low levels of proprietary resin and/or surfactant. The diarylide yellow was added as a powder (AAOT Diarylide Yellow 2817, pigment yellow 14; Delta Colours, Inc.). In addition to the organic pigments, silver pearlescent pigment was added to some of the formulations (Afflair® 103-grade powder; EMD Chemicals, Inc.). The color coated carbons with the silver pearlescent pigment were prepared by a two-step procedure of applying a basecoat spray of PE emulsion containing pigments, followed by a pigment-free topcoat spray of PE emulsion. The coated activated carbons were then dried for 16 hours at 220° F. (105° C.). Comparative samples are presented for carbons without a coating (C4) and without pigment in the coating (C5). Initial dust and dust rate values for the samples in Example 3 were measured according to the “Standard Test Method for Dusting Attrition of Granular Carbon” (ASTM D5159-91) where six consecutive filters were used for determining dust properties.

As shown in Table III, attractive color coated carbons were prepared by the organic pigments added as powder and as dispersions (samples 9-11). Samples 12 and 13 show the advantage of adding an opacity pigment in addition to the cyan and magenta pigments, in order to attain the same hues in the coated carbons as the starting organic pigments. The same benefits of low dusting, retained packing density, and retained adsorptive properties were attained by the color coated carbons (samples 9-13) compared with the coated carbon without pigment (comparative sample C5).

TABLE III

| | Sample ID: | | | | | | |
|---|---|---|---|---|---|---|---|
| | C4 | C5 | 9 | 10 | 11 | 12 | 13 |
| Base Coat | | | | | | | |
| PE, | — | 2.0 | 1.4 | 1.4 | 1.4 | 0.7 | 0.7 |
| g/100 g-carbon | | | | | | | |
| Yellow, | — | 0 | 0.5 | 0 | 0 | 0 | 0 |
| g/100 g-carbon | | | | | | | |
| Magenta, g- | — | 0 | 0 | 1.1 | 0 | 1.1 | 0 |
| solids/100 g- | | | | | | | |
| carbon | | | | | | | |
| Cyan, g- | — | 0 | 0 | 0 | 0.9 | 0 | 0.9 |
| solids/100 g- | | | | | | | |
| carbon | | | | | | | |
| Silver, g/100 g- | — | 0 | 0 | 0 | 0 | 1.0 | 1.0 |
| carbon | | | | | | | |
| Top Coat | | | | | | | |
| PE, g/100 g- | — | — | — | — | — | 0.5 | 0.5 |
| carbon | | | | | | | |
| Product | | | | | | | |
| Properties | | | | | | | |
| Product Color | Flat | Glossy | Glossy | Glossy | Glossy | Shiny | Shiny |
| | black | black | yellow- | dark brick | dark red- | magenta | cyan |
| | | | green | red | violet | | |
| Apparent | 0.358 | 0.372 | 0.366 | 0.369 | 0.367 | 0.375 | 0.371 |
| Density, g/cc | | | | | | | |
| Packing Ratio | 1.000 | 1.019 | 1.004 | 1.005 | 1.003 | 1.014 | 1.005 |
| Initial Dust, | 11.6 | 1.6 | 1.4 | 0.3 | 0.7 | 1.0 | 2.0 |
| mg/dL | | | | | | | |
| Dust Rate, | 0.73 | 0.03 | 0.02 | 0.06 | 0.05 | 0.03 | 0.00 |
| mg/min/dL | | | | | | | |
| Butane | 39 | 37 | 38 | 37 | 37 | 37 | 37 |
| Activity, | | | | | | | |
| g/100 g-product | | | | | | | |
| Butane | 39 | 38 | 38 | 38 | 38 | 38 | 38 |
| Activity, | | | | | | | |
| g/100 g-carbon | | | | | | | |
| Butane | 13.8 | 13.8 | 13.8 | 13.5 | 13.7 | 13.9 | 13.7 |
| Activity, g/dL- | | | | | | | |
| bed | | | | | | | |
| BWC, g/dL | 11.8 | 11.8 | 11.7 | 11.7 | 11.7 | 11.8 | 11.6 |
| Butane Ratio | 0.855 | 0.852 | 0.850 | 0.863 | 0.854 | 0.849 | 0.850 |

### EXAMPLE 4

Experiments failed to make color coated activated carbons by adding water soluble dyes. The coating method of Example 2 was used with MeadWestvaco RGC 40 wood-based activated carbon with the addition of dyes to the spray emulsion. The water soluble dyes were FD&C Yellow 5 and Red 3 & 40 food dyes (McCormick & Co., Inc.). The amounts of dye added to the spray emulsion were selected so that the resulting amounts of dye in the coating would be volumetrically similar to the amounts of organic and inorganic pigments that were otherwise able to attain color on the carbon (i.e., the same volumetric content of colorant in the coating according to the differences in specific gravities of the dyes and pigments). As shown in Table IV, color could not be attained by the addition of either type of soluble dye despite numerous variations in the preparation method. These variations included the basic method of spraying an emulsion and dye mixture directly on activated carbon (comparative samples C6, C7, and C8), initially color coating the carbon with a silver color opacity pigment prior to spraying with dye-laden emulsion (comparative sample C9), pre-wetting silver color coated carbon with water prior to spraying with dye-laden emulsion (comparative sample C10), and co-mixing silver color pigment and dye in the spray emulsion (comparative sample C11). When the silver pearlescent pigment was added with the soluble dye in any order of preparation, the result was the same in appearance as a silver color coated carbon without dye (sample 14) that was prepared according to the method of this invention.

The intended purpose of pre-coating with pigment or adding pigment with the dye in the spray was to establish a background silver color against which the dye might be visible when present in an exterior coating, similar to the silver pearlescent pigment added with the organic pigments in preparing samples 12 and 13 in Example 3. The intended purpose of pre-wetting the activated carbon was to prevent or hinder bulk transport of the dye-containing spray into the carbon's porosity. Regardless of the method, the dyes were not visible on the exterior coatings despite the strong presence of the red or yellow dye in the spray. When the treated activated carbons were dried and then placed in water, the dyes rapidly leached from the carbon and colored the water, proving that the dyes had indeed contacted the carbon but yet were immediately adsorbed upon contact with the carbon. Therefore, it was proven that water insoluble pigment is critical to yield color coated carbon, at least by the spray emulsion method. Besides not yielding a color coated carbon, the behavior of soluble dyes in certain applications may be especially undesirable. For example, in liquid or water filtration applications for coated carbon, the soluble colorant could leach into the effluent stream as a contaminant.

TABLE IV

| | Sample ID: | | | | | | |
|---|---|---|---|---|---|---|---|
| | 14 | C6 | C7 | C8 | C9 | C10 | C11 |
| Starting | Sample | Sample | Sample | Sample | Sample | Sample | Sample |
| Carbon | C3 | C3 | C3 | C3 | 14 | 14 | C3 |
| Spray PE, | 7.5 | 8.5 | 3.1 | 2.9 | 2.9 | 2.9 | 2.9 |
| wt % in emulsion | | | | | | | |
| Spray Dye, | — | 4.2 | 1.5 | 7.3 | 7.3 | 7.3 | 7.3 |
| wt % in emulsion | | | | | | | |
| Spray | 4.3 | — | — | — | — | — | 5.8 |
| Pigment, wt % | | | | | | | |
| in emulsion | | | | | | | |
| Added PE, | 3.5 | 1.0 | 1.0 | 1.0 | 1.0 | 1.0 | 1.0 |
| g/100 g-carbon | | | | | | | |
| Added Dye, | — | 0.5 | 0.5 | 2.5 | 2.5 | 2.5 | 2.5 |
| g/100 g-carbon | | | | | | | |
| Added | 2.0 | — | — | — | — | — | 2.0 |
| Pigment, | | | | | | | |
| g/100 g-carbon | | | | | | | |
| Pre-Color | no | no | no | no | yes | yes | no |
| Coated? | | | | | | | |
| Pre-Wetted? | no | no | no | no | no | yes | no |
| Product Color | Shiny silver | Glossy black | Glossy black | Glossy black | Shiny silver | Shiny silver | Shiny silver |

While the preferred embodiments of the present invention have been described, it should be understood that various changes, adaptations, and modifications may be made thereto without departing from the spirit of the invention and the scope of the appended claims. It should be understood, therefore, that the invention is not to be limited to minor details of the illustrated invention shown in preferred embodiment and the figures and that variations in such minor details will be apparent to one skilled in the art. The claims, therefore, are to be accorded a range of equivalents commensurate in scope with the advances made over the art.

1. A colored activated carbon comprising an activated carbon material having a polymer coating, said coating further comprising at least one insoluble colorant.

2. The colored activated carbon of claim 1 wherein the activated carbon material is of a form selected from the group consisting of particulates, beads, granules, pellets, fibers, blocks, monoliths, honeycombs, fabrics, and sheets, and combinations thereof.

3. The colored activated carbon of claim 1 wherein the polymer is selected from the group consisting of polyolefins, polyethylene, polypropylene, polyisobutylene, polystyrene, polyisoprene, polychloroprene, poly-4-methyl-1-pentene, polybutadiene, polybutene; polyacrylics, polyacrylates, polymethyl methacrylate, polybutylmethacrylate, polymethacrylates, polyacrylic acid, halogen-substituted alkanes, polytetrafluoroethylene, trifluoroethylene, vinyl fluoride, fluorvinylidene, fluorobutylene, and fluoropropylene, polyurethane, polyethylene terephthalate, styrene butadiene, modified polybutadiene, epoxies, modified alkyds, polyesters, starches, methyl cellulose, ethyl cellulose, carboxymethyl cellulose, polyvinyl acetate, cellulose acetate, cellulose nitrate, cellulose triacetate, cellulose acetate butyrate, cellulose acetate phthalate, cellulose propionate morpholinobutyrate, hydroxypropylmethyl cellulose, ethylene vinyl acetate, acrylic copolymers, polysulfones, polyether sulfones, polyethers, polyalkylene glycols, polyimines, polybutylene, polyvinyl ethers, polyvinyl esters, polyalkylsulfides, polyarylsulfides, lignosulfonates, polyacrylamide, cyanoacrylate, polyamides, polyimides, polysiloxanes, polymethacrylonitrile, polyacrylonitrile, polyvinylpyridine, polyvinyl acetate, polyvinylpyrrolidone, polyvinyl butyral, polyvinyl alcohol, polyvinyl chloride, polyvinyl formal, polyformaldehyde, polycarbonates, and polyvinylidene chloride.

4. The colored activated carbon of claim 3 wherein the polymer is polyethylene.

5. The colored activated carbon of claim 1 wherein the activated carbon is derived from a member of the group of carbon precursors consisting of coal, lignocellulosic materials, petroleum, bone, and blood.

6. The colored activated carbon of claim 5 wherein the lignocellulosic materials are selected from the group consisting of pulp, paper, residues from pulp production, wood chips, sawdust, wood flour, nut shell, kernel, and fruit pits.

7. The colored activated carbon of claim 1 wherein the insoluble colorant is selected from the group consisting of insoluble colorants consisting of organic and inorganic compounds.

8. The colored activated carbon of claim 7 wherein the insoluble colorant is selected from the group consisting of powders, dispersions, chromophores grafted to an insoluble solid additive, colorants immobilized in the polymer, and chromophores grafted to the polymer.

9. The colored activated carbon of claim 8 wherein the insoluble colorant is an indicator compound.

10. The colored activated carbon of claim 9 wherein the indicator compound is selected from the group consisting of compounds that gain color, change color, and lose color.

11. A method for coloring activated carbon by coating activated carbon material with at least one film layer of polymer emulsion, wherein the polymer emulsion includes at least one insoluble colorant.

12. The method of claim 11 wherein the color-coated activated carbon material is prepared by the steps of:
(a) spraying insoluble colorant-containing polymer emulsion onto exposed surfaces of the activated carbon, and
(b) drying the coated activated carbon material.

13. The method of claim 12 comprising a further step of:
(c) de-dusting the dry, coated activated carbon material by removing any residual dust therefrom.

14. The method of claim 11 wherein the polymer is selected from the group consisting of polyolefins, polyethylene, polypropylene, polyisobutylene, polystyrene, polyisoprene, polychloroprene, poly-4-methyl-1-pentene, polybutadiene, polybutene; polyacrylics, polyacrylates, polymethyl methacrylate, polybutylmethacrylate, polymethacrylates, polyacrylic acid, halogen-substituted alkanes, polytetrafluoroethylene, trifluoroethylene, vinyl fluoride, fluorvinylidene, fluorobutylene, and fluoropropylene, polyurethane, polyethylene terephthalate, styrene butadiene, modified polybutadiene, epoxies, modified alkyds, polyesters, starches, methyl cellulose, ethyl cellulose, carboxymethyl cellulose, polyvinyl acetate, cellulose acetate, cellulose nitrate, cellulose triacetate, cellulose acetate butyrate, cellulose acetate phthalate, cellulose propionate morpholinobutyrate, hydroxypropylmethyl cellulose, ethylene vinyl acetate, acrylic copolymers, polysulfones, polyether sulfones, polyethers, polyalkylene glycols, polyimines, polybutylene, polyvinyl ethers, polyvinyl esters, polyalkylsulfides, polyarylsulfides, lignosulfonates, polyacrylamide, cyanoacrylate, polyamides, polyimides, polysiloxanes, polymethacrylonitrile, polyacrylonitrile, polyvinylpyridine, polyvinyl acetate, polyvinylpyrrolidone, polyvinyl butyral, polyvinyl alcohol, polyvinyl chloride, polyvinyl formal, polyformaldehyde, polycarbonates, and polyvinylidene chloride.

15. The method of claim 14 wherein the polymer is polyethylene.

16. The method of claim 11 wherein the active carbon material is derived from a member of the group consisting of coal, lignocellulosic materials, petroleum, bone, and blood.

17. The method of claim 16 wherein the lignocellulosic materials are selected from the group consisting of including pulp, paper, residues from pulp production, wood chips, sawdust, wood flour, nut shell, kernel, and fruit pits.

18. The colored activated carbon of claim 11 wherein the insoluble colorant is selected from the group consisting of organic and inorganic compounds.

19. The colored activated carbon of claim 18 wherein the insoluble colorant is selected from the group consisting of powders, dispersions, chromophores grafted to an insoluble solid additive, colorants immobilized in the polymer, and chromophores grafted to the polymer.

20. The colored activated carbon of claim 19 wherein the insoluble colorant is an indicator compound.

21. The colored activated carbon of claim 20 wherein the indicator compound is selected from the group consisting of indicator compounds that gain color, change color, and lose color.

22. The method of claim 11 where the form of the activated carbon is selected from the group consisting of particulates, beads, pellets, fibers, blocks, monoliths, honeycombs, fabrics, and sheets, and combinations thereof.

23. A filter for removing contaminants comprising activated carbon with a coating of polymer and at least one insoluble colorant.
